(19) United States
(12) Patent Application Publication
(10) Pub. No.: US 2020/0349560 A1
(43) Pub. Date: Nov. 5, 2020

(54) Automated Pet Recovery and Rescue Network

(71) Applicants: Christopher Adam Samples, (US); Polina Gunter Samples, (US)

(72) Inventors: Christopher Adam Samples, Hiram, GA (US); Polina Gunter Samples, Hiram, GA (US)

(21) Appl. No.: 16/865,674

(22) Filed: May 4, 2020

Related U.S. Application Data
(60) Provisional application No. 62/843,391, filed on May 4, 2019.

(51) Int. Cl. G06Q 20/38; G06Q 20/32; G06Q 50/00; G06Q 30/02; G06Q 20/30; G06Q 20/36; G06F 21/62; G06F 16/955; G06K 19/06; H04W 4/021; H04W 4/029; A01K 27/00; A01K 11/00; A01K 29/00

(52) U.S. Cl. CPC G06Q 20/384; A01K 29/005; G06Q 50/01; G06Q 20/386; G06Q 30/0282; G06Q 20/308; G06Q 20/3678; G06F 21/6245; G06F 16/9554; G06K 19/06037; H04W 4/021; H04W 4/029; A01K 27/009; A01K 11/008; G06Q 20/3267

(57) ABSTRACT

In essence, the proposed network is meant to provide a platform for prompt pet recovery. Through the establishment and integration of an IoT network consisting of smart pet collars with digital wallets, event triggers which alert a network of individuals when a pet has escaped with available location information, and private user profiles so that those who recover lost pets can be easily rewarded, the proposed network will establish incentives for the decentralized recovery of lost and endangered pets.

Since this system will allow owners to increase the reward incentive on the fly, and individuals recovering the animals are rewarded on a first come first serve basis; this network will establish an environment in which a decentralized community may compete to be the first one to save the animal.

### FIELD OF THE INVENTION

This invention relates to the process of networking pet owners and individuals willing to rescue escaped pets in order to provide an automated and incentivized system for reporting and recovering pets. Furthermore, this invention would use specially designed pet collars, which contain digital wallets, and would be compatible with potential outside hardware and software partners in order to create a comprehensive system for the safe recovery of pets.

### BACKGROUND

Technologies and networks currently exist that attempt to solve similar problems as the proposed network but no public network or technology exists to solve the same problems specifically.

Network platforms designed to build communities around pet rescue are extremely limited in features and capabilities. These platforms lack the integration of existing technologies, fail to provide an enticing incentive system, and fail to provide a user-friendly and accurate method for creating one or more designated “safe zones” for pet tracking.

Existing pet tracking hardware fails to encourage and enable the recovery of these pets by individuals other than the owners. It also fails to create a custom geographical safe zone; instead selecting a certain radius around a stationary device as the safe area. This method could lead to inaccurately reporting the pet's status as safe or not safe.

Most importantly, previous attempts to develop an effective pet recovery service have failed to create a method that truly promotes immediate action to rescue the pet before they have strayed too far to find their way back home or have encountered dangerous situations.

### BRIEF SUMMARY OF THE INVENTION

The proposed invention will enable pet owners to designate one or more safe zones for any number of pets. When a pet, equipped with hardware (e.g. a collar, tag, or other device), crosses the barrier (or geofence) of the safe zone, the owner is alerted to their escape. In addition to the owner, the system can automatically (or manually, per the pet owner's preference) signal the escape to the community. The pet owner will also have the capability to assign a digital monetary value to the equipped hardware. When the pet escapes the safe zone, the otherwise private monetary reward amount becomes public knowledge to the community. Members of the community who would like to attempt to rescue the pet and collect the reward can find and recover the pet (on a first come, first serve basis) and deliver the pet to a safe location pre-determined by the owner. Once the pet is confirmed safe, the monetary reward will be transferred to the user who rescued the pet.

This invention will comprise of the following components but is not limited to them: a community of incentivized individuals who care about the safe recovery of pets and are willing to assist in the effort of said recovery in exchange for a monetary reward; hardware that can track the location of pets utilizing technologies such as GPS, Bluetooth, Wifi, and others that also utilizes an integrated digital wallet that enables pet owners to assign monetary rewards for the safe recovery of their pets; geobrowsing software that allows pet owners to create a custom virtual outline (geofence) around their property and the property of other frequented safe zones (including, but not limited to, veterinarian offices, pet daycares/kennels, family and friend's houses, dog parks, and other frequented locations); and a system that networks the aforementioned system components together.

### BRIEF DESCRIPTION OF THE DRAWINGS

FIG. 1—FIG. 1 depicts the technology that will be available for use with the company's or partner companies' hardware. The hardware depicted (A) could be a collar or an attachment for a collar (tag) that will house technologies to facilitate Bluetooth connectivity (B), WiFi connectivity (C), GPS tracking (D), and digital representation of a monetary reward stored elsewhere on the network, or digital wallet (E).

FIG. 2—FIG. 2 depicts a representation of the geomapping software the pet owner will use to specify the pet's safe zone. The pet owner will be able to locate their house, or another property, and free draw/trace an outline, creating a custom GPS boundary (F).

FIG. 3—FIG. 3 depicts a representation of the geomapping software the pet owner will use to specify the pet's safe zone. This pet owner chose to create a fence around their own yard (G) as well as a neighbor's yard (H) because the neighbor often watches the pet while the pet owner is away. In this instance, the pet would be considered “safe” if his GPS coordinates were within either boundary.

FIG. 4—FIG. 4 represents the process by which the proposed invention would enable pet owners and incentivized individuals to work together to securely recover lost pets.

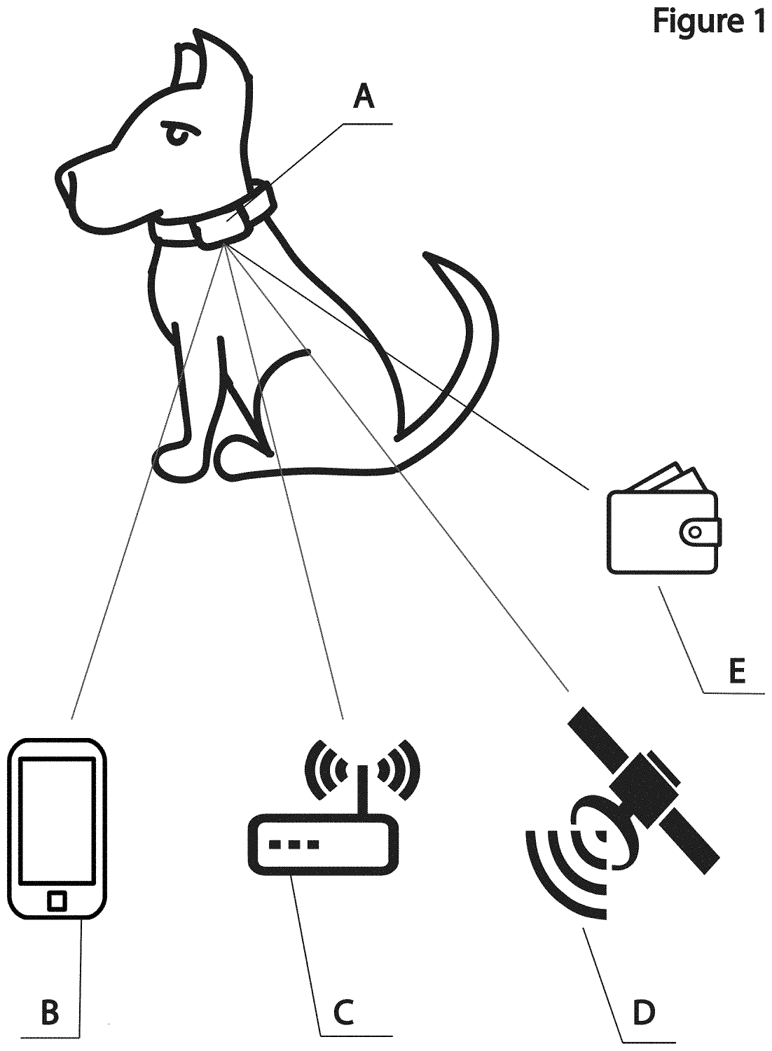

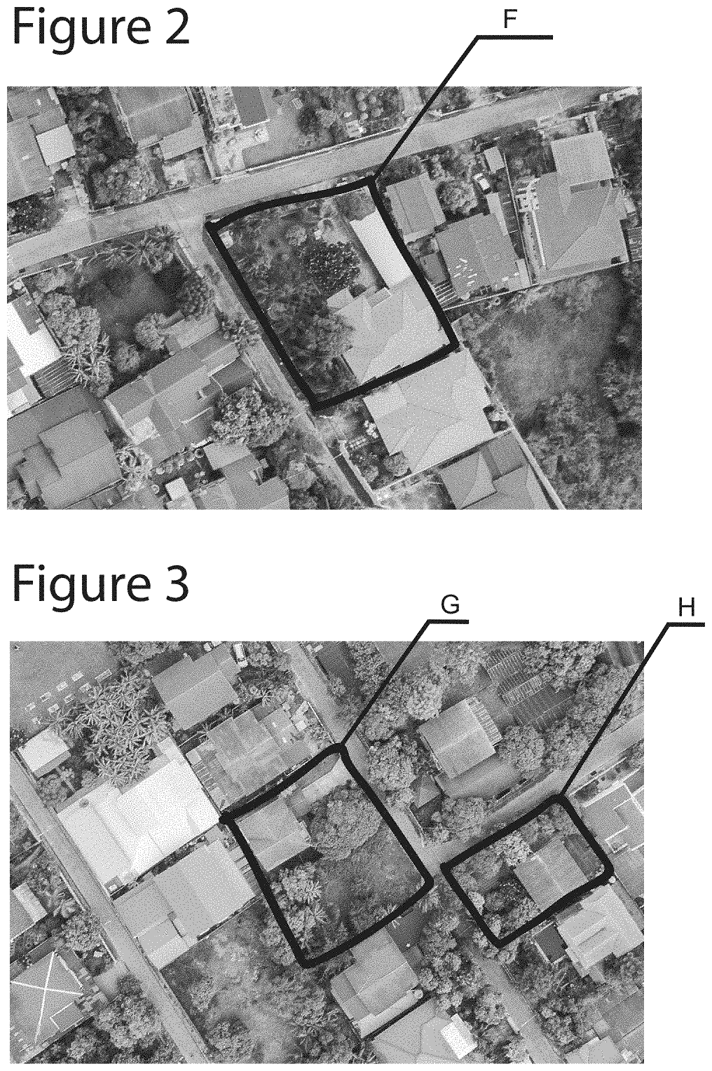

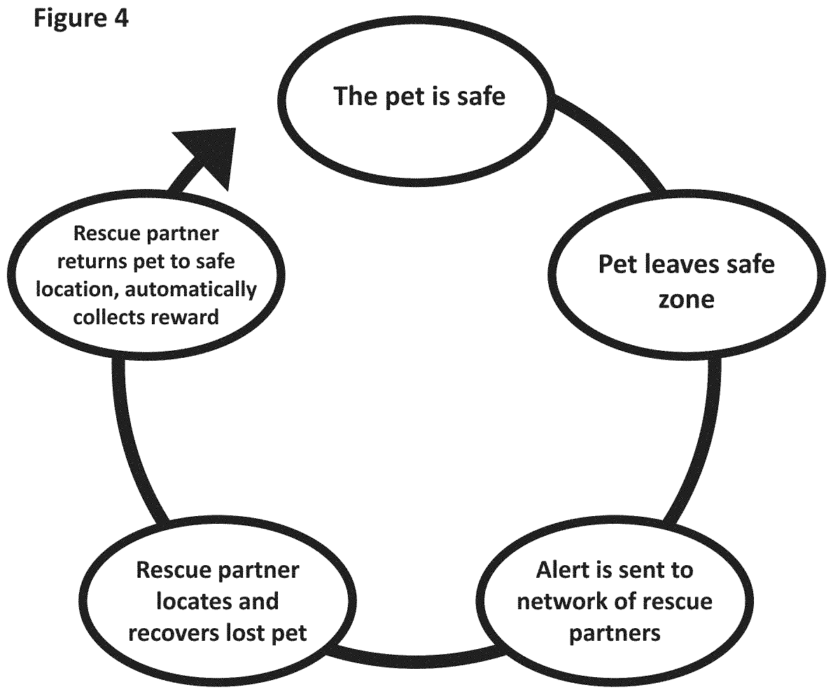

### DETAILED DESCRIPTION OF THE INVENTION

Some possible functions of the network are described in the following section by discussing available features from four perspectives; the pet owner, the community member interested in recovering lost pets in exchange for a monetary reward, the animal control or animal shelter authorities, and the general users.

### Pet Owners

The proposed service will provide pet owners a new avenue for the recovery of their lost or escaped pets. This network will create motivation to rescue pets in a timely manner.

The pet owner will purchase and equip their pet with the system hardware (features may include but are not limited to; GPS, wireless connectivity, Bluetooth, and portable WiFi routers). Then, the pet owner can use the online network to create a pet profile that will be linked to the pet's hardware. This profile will consist of details including, but not limited to, the pet's name, the pet's physical description, the pet's preferences, favorite treats, and dislikes. The owner will also be able to assign a monetary reward to the pet's profile in order to incentivize the community to rescue the pet in the event that the pet escapes or becomes lost. The pet's profile is kept private until the pet is determined to have left one of his geographically selected safe zones (geofence). If the pet owner elects to allow the release of the information, the pet's profile, along with the reward amount and the pet's latest known GPS coordinates, will be released to members of the community.

The pet tracking hardware will connect to the pet owner's home network (e.g. Wifi)—or phone network (e.g. Bluetooth) when the pet owner is traveling with the pet and the designated safe zone is not stationary—instead of GPS when they are still in the safe zone in order to conserve battery life. Once the tracking hardware disconnects from the pet owner's network, the GPS capability will automatically turn on and begin to verify the pet's location. If the GPS device determines that the pet is still within the geofence (either the owner's network has malfunctioned or the pet has made it into a part of the safe zone that is not accessible by the pet owner's network), the GPS will continue to monitor the pet's location until he returns to the range of the network. In the event that the GPS scan discovers that the pet has indeed wondered past the borders of the geofence, the owner will automatically be alerted and (according to the owner's preferences) the dog recovery community may also be notified automatically or manually by the owner.

The pet owner may elect whether the system should automatically send the pet's information to the community or allow the pet owner to manually release that information (this feature would be useful for occasions when the pet manages to wonder past the geofence but is still recoverable by the owner because he is nearby—the pet owner could elect to receive a notification for manual release while he is home and an automatic release while he is away and not available to recover the pet himself).

The pet owner will use the online application designed by the company as part of the service to draw a customized digital border around any areas the pet owner would like to assign as safe zones (along the borders of the pet owner's property, or the area of his fenced-in yard, for example) using geomapping software.

Additional features that may be available on the network include, but are not limited to: the ability to track pets while they are on a walk with a pet walker in real-time; a feature that tracks pet's activity level based on location/geographical movement and provides statistics regarding health benefits and needs (based on pet information provided by the pet owner such as pet age, breed, weight, etc.); an integrated community of pet owners, pet rescuers, and pet professionals (features of which could include discussion forums, listings for services and/or goods, reviews/feedback about pet professionals, etc). This network and the hardware discussed will also be compatible with any future partners in order to improve the product and create a more complete, all-in-one service/product.

The pet owner may also choose a default method of pet return, including, but not limited to: return at the pet owner's house; return at a public location; return at the location of a local authority such as a police station, a fire station, or animal shelter. In the event that a pet has travelled an excessive distance from home, the owner may need to travel to the rescue location in order to retrieve the pet.

### Pet Rescue Community

Interested individuals can become part of the network by signing up for a “rescue partner” account. This account would grant the individuals access to listings of missing pets, their last known geographical locations, and the pet profile set up by the pet owners (which contains details such as pet name, physical description, likes and dislikes, etc) as well as the amount of the reward offered for the safe return of the pet. These community members may use the community website and/or app to conduct a search for lost pets, as well as create parameters in order to receive notifications of lost pets. These individuals may update their profile preferences in order to receive notifications of lost pets most suited for their capabilities and preferences. For example, rescue partners may indicate several filters for both search and notification features, including, but not limited to: geographical area, distance from their own location, distance lost pet has travelled, days the pet has been missing, range of the monetary reward, size/age/characteristics of the pet, etc. There is no sensitive or personal information about the pet owners themselves present on these profiles.

Once the rescue partner has received a missing pet notification, they can set a status of “in pursuit” or choose to do nothing. More than one rescue partner can indicate pursuit of a lost pet and the number of rescue partners in pursuit will be revealed to the pet owner, the other rescue partners in pursuit, and rescue partners interested in pursuit. Once a partner has indicated pursuit status, they will be able to track the pet's GPS location in real-time as it is available. Once the user has located the pet, they can use the details provided regarding the pet's characteristics to guide the pet to safety. Once the pet is safely in the partner's custody, they may indicate a status of “rescued” and proceed in one of the following manners (or any other options determined in the future), per the pet owner's specification: they may meet the owner at the owner's house; they may meet the owner a public location; they may meet the owner at the location of a local authority such as a police station, a fire station, or animal shelter; they may drop the pet off at a participating authority's location (such as an animal shelter or animal control office) for the pet owner's retrieval later; they may drop the pet off at another participating provider, including, but not limited to a veterinarian office and a pet daycare/kennel. If the pet has travelled an excessive distance (parameters to be determined by the rescue partner and/or the owner) from home, options will be available for the rescue partner and pet owner to meet closer to the rescue partner's location. Once the pet's status is designated/determined as “safe,” (which will be determined automatically by the system, although manual verification may be available) the reward (assigned on the digital wallet that is linked to the hardware equipped to the pet) is credited to the rescue partner who safely recovered said pet. If the partner is in pursuit but not able to recover the pet, they may take a picture of the pet to help confirm the pet's condition and location to assist in its eventual recovery. When a partner uploads a photo that helps to lead to a rescue, they will be rewarded a non-monetary credit (possibly based on a point system) that can be exchanged for partner rewards.

Pet profiles are only available to the community when the pet is missing. Therefore, a feature can be provided that adds a discussion/notification forum to each pet's profile, once it has been activated. This feature will enable rescue partners to add updates and notifications regarding their efforts and the pet's condition and whereabouts as the attempted rescue progresses.

### Animal Control/Animal Shelters

The network also intends to assist animal rescue authorities by providing a reliable record of lost pets. These users, once verified, will have access to all lost pets' GPS coordinates and profile data within their jurisdiction. The authorities, if they locate a lost pet, can use the website and/or application to privately contact the pet owner to return the pet. The owner, once the pet is recovered, can opt to donate to the authority part or all of the reward that was offered for the pet's safe recovery by a private citizen. Additionally, the physical descriptions of the pets available on their profiles (once they have become lost) will assist authorities in identifying missing pets on the network that have been recovered by the authority but have lost their collar or other tracking hardware.

Because pet owners may choose to have their pet delivered to an authorized animal rescue authority location, these participating locations will receive a notification ahead of time that a pet rescued through this service will be arriving for drop off and the approximate timing of the pet owner's retrieval of the pet.

### General Users

General users will be pet owners, pet care providers, and other individuals/entities who have an interest in the pet recovery network. These users may have access to discussion forums, listings for pet products and services, and a lost and found forum specifically created for the assistance in recovery of pets who are not on this network. General users will be able to use this forum to post lost and recovered pet announcements and updates. These users will not have access to the profiles of the lost pets on the network unless they register for rescue partner accounts.

Additionally, if an unregistered user happens to find/rescue a participating pet without knowing about the network, instructions for network use (URL to the website or scan code for the app, for example) will be available on the pet's collar/tag/other tracking hardware that will point the user to the network, where they will find options to safely return the dog (the user may be prompted to choose one of several methods, such as creating an account, logging into an existing account, or simply filling out an information form that will be sent to the pet owner in order to facilitate the recovery of the pet).

Because the main mission of the network is the safe recovery of pets, this company will facilitate the compatibility of existing hardware that utilizes the same or similar tracking technology and will pursue partnerships with existing providers in order to create a more extensive network. Pet owners may use any participating hardware that they already possess to connect to the network. The company will create multiple lines of the hardware, each with specific features, including but not limited to: a collar and/or tag equipped with GPS, WiFi, Bluetooth, and digital wallet link capabilities; a collar and/or tag equipped with WiFi, Bluetooth, and digital wallet link capabilities; a collar and/or tag with Wifi and digital wallet link capabilities; a collar and/or tag with Bluetooth and digital wallet link capabilities; a collar and/or tag with digital wallet link capabilities. Therefore, the pet owner can “mix and match” existing (compatible) hardware and this company's hardware in order to create the proper coverage of capabilities in order to use the network's features.

Blockchain technology may be used by this network as a digital store of value. Digital representations of fiat currency values may also be used. Blockchain may also be used by this network to assure that transactions and records on the network remain immutable, private, and secure.

1. A system that facilitates the automation of the recovery of lost or escaped cats or dogs and returning them to their families.

2. A pet profile that a pet owner user can create to list their pet's information, including but not limited to: species, breed, size, color, name, temperament, likes and dislikes, favorite treats, likely aversions, and other information that may be helpful in recovery and is otherwise kept private.

3. The system of claim one, wherein a pet owner user may use the geofencing feature of the system to create one or more designated safe areas where the pet is considered safe and therefore the profile of claim two and location data is private while not in use.

4. The system of claim one, wherein the pet's location is monitored using a “smart” tracking collar, chip, tag, or other device in the case of escape, wherein an alert is automatically sent to the network upon a pet's escape from the safe area of claim three.

5. The system of claim one; wherein the lost pet's location tracking data, profile, reward amount, and rescue parameters can be set by the pet parent user during account setup.

6. The system of claim one; wherein the lost pet's real-time location data, profile, reward amount, and rescue parameters from claim five are automatically released to the network participants who then recover the lost pet for the reward.

7. The system of claim one, wherein the pet owner user may elect not to send an automatic alert when their pet escapes and may choose to manually send the alert.

8. The system of claim one, wherein the reward set by the pet owner is automatically awarded to the network participant when the pet is safely returned.

9. The system from claim one; wherein network participants (Rescue Partners) use an app to track lost pet location, review the pet's profiles, communicate with lost pet owners to facilitate their rescue of the lost pet; through which they receive their secure automatic payment after recovery and return of the lost pet.

10. A proprietary pet collar, chip, tag, or other tracking device with GSM, GPS, Bluetooth, and or additional technologies to enable the collar/device to be tracked when the collar/device is used in conjunction with a service that shares real time tracking data with the pet owner and willing additional parties so that they can help to recover the lost pet.

11. The collar, chip, tag, or other tracking device of claim nine, which functions directly with the system of claim one to allow pet owner users to allow their pet's location to be tracked on the network in the case of escape.

12. The system of claim one, which can use both the location data from the proprietary device from claims nine and ten, which is especially created for this system, as well as tracking devices already existing in the marketplace in order to make the system available to anyone with a tracking device.

13. The system of claim one, which can also be used by pet owner users who do not have a collar or other tracking device, wherein the user will be able to send manual alerts to the network in order to benefit from the network of available participants and other features of the system but will not be able to track their pet's location and will not be able to allow others to track their pet's location for rescue.

14. The system of claim one, wherein alerts of the lost pet are automatically sent out in the event of escape which display the pre-set reward amount, but users retain the ability to change the reward amount.

15. A digital payment method that matches and delivers the custom set reward amount for the lost animal to the network participant who first successfully recovers the animal.

16. A method for automatically checking that specific criteria for pet services are followed and then paying the reward amount to the network participant's account.

17. A feature of the system of claim one that allows network participants to elect to divide the reward amount amongst multiple rescue partners based on teamwork or nearby dangers.

18. The system of claim one, wherein the location tracking and other functionality of the system is used for multiple other uses, including but not limited to dog walking, pet sitting, etc, to allow the pet owner user to track the performance of their service provider and pet's well-being and location.

19. The system of claim one, wherein the rescue network users can set search filters to search for specific lost pets, including but not limited to, location, distance from location choice, days lost, species of pet, breed of pet, size of pet, temperament and other characteristics of pet, reward amount, etc.

20. A method for ranking and reviewing network participants who recover lost cats and dogs based on customer reviews and location data from the network participant as compared to lost animal location data.

21. An automated IoT network that is designed to automate a process by which individuals may
recover lost animals on a first come first serve basis for a preset reward set to the task of recovering the animal
the process by which rescue partners that can recover a pet is verified as having returned the pet, and is paid for a safe recovery
the process by which a pet owner can respond and approve or disapprove of an alert in the event their pet triggers the system to dispatch rescue partners

22. A pet collar having a strap and a housing held by the strap, or an attachment for an existing collar comprising:
a digital wallet module configured to wirelessly connect to the network to host a digital representation of a monetary amount;
a QR digital code, or other key or code that can be used to represent a digital wallet elsewhere on the network;
a QR digital code, or other key or code that can be used to represent a digital profile and/or other information on the network;
a GPS module configured to wirelessly transmit pet location data to pet owner and pet recovery network;
a Bluetooth module configured to wirelessly connect to pet owner's devices and transmit pet location data to the pet owner;
a WiFi module configured to wirelessly connect to pet owner's devices and transmit pet location data to the pet owner;
or any other combination of the above features.
